(19) United States
(12) Patent Application Publication
(10) Pub. No.: US 2023/0077822 A1
(43) Pub. Date: Mar. 16, 2023

(54) OPTICAL SYSTEM AND PROJECTION DISPLAY APPARATUS

(71) Applicant: CANON KABUSHIKI KAISHA, Tokyo (JP)

(72) Inventor: Ryo Iijima, Tochigi (JP)

(21) Appl. No.: 17/902,058

(22) Filed: Sep. 2, 2022

(30) Foreign Application Priority Data
Sep. 7, 2021 (JP) 2021-145151

(51) Int. Cl. G02B 9/64; G03B 3/00; G03B 21/14

(52) U.S. Cl. CPC G02B 9/64; G03B 3/00; G03B 21/142

(57) ABSTRACT

Provided is a projection lens including: a first optical system configured to form an intermediate image from an enlargement conjugate side toward a reduction conjugate side; and a second optical system configured to image the intermediate image onto an imaging plane on the reduction conjugate side, wherein the first optical system at least includes a first lens unit having a negative refractive power and a second lens unit having a positive refractive power, wherein the second lens unit is arranged on the reduction conjugate side with respect to the first lens unit, and wherein the first lens unit and the second lens unit are configured to move in different trajectories on an optical axis so that curvature of field is adjusted.

### BACKGROUND OF THE INVENTION

### Field of the Invention

The present disclosure relates to an optical system and a projection display apparatus.

### Description of the Related Art

In recent years, as usage applications of a projector, there have been applications of projecting an image onto not only a plane screen but also a curved screen. In order to project an image having less blur with respect to both of the plane screen and the curved screen, there is a demand for a projection lens having a configuration capable of adjusting curvature of field.

In Japanese Patent No. 6469284, there is disclosed a projection lens in which a focus lens unit and a field curvature adjustment lens unit arranged on a reduction conjugate side with respect to a stop are simultaneously driven so that adjustment of the curvature of field is achieved.

In Japanese Patent No. 6469284, a back focus is varied by driving the field curvature adjustment lens unit on the most reduction conjugate side. However, the lens on the most reduction conjugate side has a very high sensitivity with respect to the back focus, and hence fine driving is required.

### SUMMARY OF THE INVENTION

The present disclosure has an object to provide an optical system capable of satisfactorily adjusting curvature of field with a simple configuration.

According to the present disclosure, there is provided an optical system including: a first optical system configured to form an intermediate image from an enlargement conjugate side toward a reduction conjugate side; and a second optical system configured to image the intermediate image onto an imaging plane on the reduction conjugate side, wherein the first optical system at least includes a first lens unit having a negative refractive power and a second lens unit having a positive refractive power, wherein the second lens unit is arranged on the reduction conjugate side with respect to the first lens unit, and wherein the first lens unit and the second lens unit are configured to move in different trajectories on an optical axis so that curvature of field is adjusted.

According to the present disclosure, the optical system capable of satisfactorily adjusting the curvature of field with a simple configuration can be provided.

Further features of the present invention will become apparent from the following description of exemplary embodiments with reference to the attached drawings.

### BRIEF DESCRIPTION OF THE DRAWINGS

FIG. 1 is a schematic view of a projection lens (L1) of Example 1.

FIG. 2A shows graphs of planar projection in the projection lens (L1) of Example 1.

FIG. 2B shows graphs of pseudo-curved projection in the projection lens (L1) of Example 1.

FIG. 2C shows graphs of results obtained after curvature of field is adjusted in the projection lens (L1) of Example 1.

FIG. 3 is a schematic view of a projection lens (L2) of Example 2.

FIG. 4A shows graphs of planar projection in the projection lens (L2) of Example 2.

FIG. 4B shows graphs of pseudo-curved projection in the projection lens (L2) of Example 2.

FIG. 4C shows graphs of results obtained after curvature of field is adjusted in the projection lens (L2) of Example 2.

FIG. 5 is a schematic view of a projection lens (L3) of Example 3.

FIG. 6A shows graphs of planar projection in the projection lens (L3) of Example 3.

FIG. 6B shows graphs of pseudo-curved projection in the projection lens (L3) of Example 3.

FIG. 6C shows graphs of results obtained after curvature of field is adjusted in the projection lens (L3) of Example 3.

FIG. 7 is a schematic view for illustrating a configuration of a projection display apparatus having mounted thereon an optical system according to the present disclosure.

### DESCRIPTION OF THE EMBODIMENTS

### EXAMPLE 1

Preferred embodiments of the present invention will now be described in detail in accordance with the accompanying drawings.

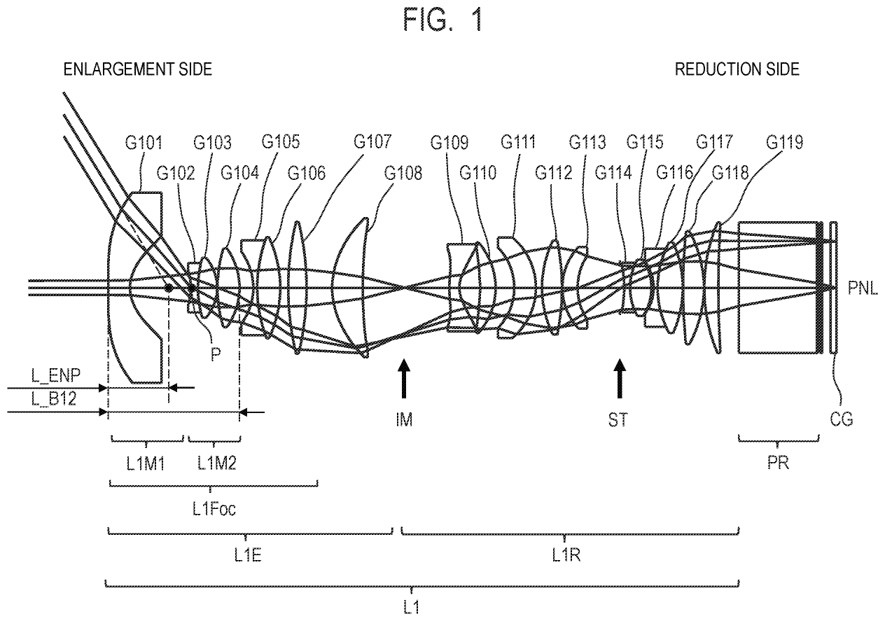

Now, a projection lens L1 (optical system) of Example 1 of the present disclosure is described with reference to FIG. 1. FIG. 1 is a schematic view for illustrating a lens configuration of the projection lens L1 of Example 1. In FIG. 1, an enlargement side is an enlargement conjugate side, and a reduction side is a reduction conjugate side. Further, common matters in Examples are also described through use of Example 1 as an example.

The projection lens L1 of Example 1 is a projection optical system to be used in a projection display apparatus (projector). The projection optical system is designed assuming a state in which light rays enter the projection optical system from the enlargement conjugate side serving as an object plane so as to travel toward the reduction conjugate side. The projection optical system is a color separation/combination optical system for a total reflection prism (TIR prism) for a digital mirror device (DMD), or for a reflective or transmissive liquid crystal display element. A plane on which an image is formed on the reduction conjugate side is an imaging plane PNL. The projection lens L1 of Example 1 may be used as an image pickup optical system to be used in a camera or the like. When the projection lens L1 of Example 1 is used as the image pickup optical system, an image pickup element may be arranged on the imaging plane PNL.

The projection lens L1 of Example 1 includes a plurality of lens groups. Each lens group may be formed of one lens, or may be formed of a plurality of lenses. A prism portion PR is a glass block. The prism portion PR is an optical member corresponding to a main body optical system of the projection display apparatus, and is used for correcting a length of an optical path with respect to a specific illumination optical system. For example, in an optical system using a single-plate DMD panel, the prism portion PR corresponds to a TIR prism, a color filter, or the like, and in an optical system using a three-plate transmissive liquid crystal display, the prism portion PR corresponds to a color combination system, a polarizer, or the like. On the imaging plane PNL on the reduction conjugate side, an image display element (light modulation element), such as a DMD or a liquid crystal display element, is arranged. A stop is represented by ST. A cover glass for display element protection is represented by CG. The mode of Example 1 is not always limited to an optical system requiring the glass block, and a space between the projection lens L1 and the imaging plane PNL on the reduction conjugate side may be simply an air gap.

Now, the projection lens L1 of Example 1 is described. How the light rays are handled is described assuming that, similarly to the image pickup optical system, the imaging plane PNL on the reduction conjugate side serves as an image plane, and the light rays enter the projection lens L1 from the enlargement conjugate side so as to be imaged on the reduction conjugate side.

The projection lens L1 of Example 1 includes nineteen lens elements of from a lens G101 to a lens G119. The projection lens L1 is a re-imaging type optical system having an intermediate imaging plane IM inside of the projection lens L1. A screen (not shown) and the intermediate imaging plane IM are conjugate with each other, and are also conjugate with the imaging plane PNL. The projection lens L1 of Example 1 is divided into a first optical system L1E corresponding to an enlargement conjugate side optical system and a second optical system L1R corresponding to a reduction conjugate side optical system at the intermediate imaging plane IM serving as a border. The first optical system L1E is a retrofocus type wide-angle optical system, and images steeply entering light rays onto the intermediate imaging plane IM. That is, the first optical system L1E forms, from the enlargement conjugate side toward the reduction conjugate side, an intermediate image on the intermediate imaging plane IM. The second optical system L1R plays a role of a relay optical system with which the intermediate imaging plane IM and the imaging plane PNL on the reduction conjugate side are conjugate with each other. That is, the second optical system L1R re-images the intermediate imaging plane IM onto the imaging plane PNL on the reduction conjugate side. A focus optical system L1Foc is responsible for a focus function in the projection lens L1 of Example 1. The focus function is achieved by moving back and forth the entire focus optical system L1Foc at the time of varying an object distance.

Formation of a configuration of the re-imaging type optical system has an advantage in that the lens can have a small diameter while having a wide angle, and a long back focus can be ensured. In general, the image display element has an angle characteristic in the projector, and hence a telecentric optical system is required on the reduction conjugate side. Further, as described above, some kind of glass block is generally arranged between the image display element and the projection optical system. Accordingly, the projection optical system for the projector is required to be telecentric and have a long back focus. In recent years, there has been a demand for a wide-angle projector. However, in a case of a retrofocus type optical system which is widely used in the wide-angle optical system, when the long back focus is intended to be ensured, the optical system tends to be complicated, and the diameter of the lens on the most enlargement conjugate side (front lens diameter) also tends to be increased. Meanwhile, in the re-imaging type optical system, the first optical system L1E has a short-focus retrofocus type configuration, but it is not required to ensure the long back focus at the point of the intermediate imaging plane IM. The light rays are relayed by the second optical system L1R so that the back focus is ensured. Further, the imaging state of the intermediate imaging plane IM is free, and hence front and back sides of the intermediate imaging plane IM can share aberration correction regarding off axial rays which cause problems in the wide-angle system, such as distortion and astigmatism. Accordingly, a burden in terms of aberration correction is not concentrated to the first optical system L1E located on the enlargement conjugate side, and thus the diameter can be reduced.

In the projection optical system of the related art, the focus lens unit and the field curvature adjustment lens unit arranged on the reduction conjugate side with respect to the stop are simultaneously driven so that adjustment of the curvature of field is achieved. In general, when the focus group is driven under a state in which the back focus being a distance between a glass surface on the reduction conjugate side and the imaging plane on the reduction conjugate side is varied from a design state so that a screen center is focused, there is a shift from an aberration correction state that the focus group ideally has. In addition, curvature of field is caused in a peripheral portion of the screen. At this time, when a group having a large sensitivity to the back focus is driven, any focus state can be caused while leaving the curvature of field. That is, an adjusting group for adjusting the curvature of field in the related art is nothing but movement of the group having a large sensitivity to the back focus. At this time, the back focus is varied by driving the field curvature adjustment lens unit on the most reduction conjugate side. However, the lens on the most reduction conjugate side has a very high sensitivity with respect to the back focus, and hence fine driving is required. Further, the field curvature adjustment lens unit being a drive group is arranged on the reduction conjugate side, and hence there is a fear in that arrangement of a motor or the like for use in electric drive becomes complicated. Moreover, the focus group and another different lens group are required to be simultaneously driven, and hence manual adjustment is complicated and difficult. Electric drive control is expected to be required in a large number of scenes, and thus it is difficult to achieve a simple configuration.

Next, a configuration for adjusting the curvature of field in Example 1 is described. In the retrofocus type configuration, there can be easily employed a configuration of moving an optical system having a negative refractive power and being arranged on the most enlargement conjugate side or close to the most enlargement conjugate side. For example, in FIG. 1, the meniscus-shaped negative lens G101 on the most enlargement conjugate side has a strong sensitivity to the curvature of field, and hence it is conceivable to employ a method of moving back and forth the lens G101 so that the curvature of field is adjusted. However, although the first optical system L1E is a very wide-angle optical system, the first optical system L1E is an optical system which is not required to ensure performance at the intermediate imaging plane IM. Accordingly, steep off axial rays are received by the meniscus-shaped negative lens, and are guided by a positive refractive power so as to be imaged onto the intermediate imaging plane IM. Thus, the off axial rays pass through the meniscus-shaped lens G101 having a strong negative refractive power, and soon intersect with the optical axis. This intersection corresponds to a substantial stop in the first optical system L1E, and hence, in the vicinity of this intersection, the sensitivity that the lens interval change has with respect to the back focus is increased. Accordingly, the movement in the optical axis direction of the meniscus-shaped negative lens G101 on the most enlargement conjugate side causes a change in curvature of field, and simultaneously causes a change in back focus. In the retrofocus type optical system, unlike the re-imaging type optical system, the lens group having the negative refractive power and being arranged on the most enlargement conjugate side or close to the most enlargement conjugate side is generally far from the stop of the entire optical system, and hence such a problem is less liable to occur. Accordingly, it can be said that the above-mentioned problem is an issue specific to the re-imaging type projection lens.

In view of the above, according to the present disclosure, as a measure for adjusting the curvature of field, in the first optical system L1E, two optical systems, specifically, a third optical system L1M1 (a first lens unit) having a negative refractive power and a fourth optical system L1M2 (a second lens unit) having a positive refractive power, are used. In the projection lens L1 of FIG. 1, the third optical system L1M1 having the negative refractive power is formed of a lens element, specifically, the lens G101, and the fourth optical system L1M2 having the positive refractive power is formed of three lens elements, specifically, the lens G102 to the lens G104. Each of the third optical system L1M1 and the fourth optical system L1M2 may be formed of a single lens element or a combination of a plurality of lens elements. The fourth optical system L1M2 is always arranged on the reduction conjugate side with respect to the third optical system L1M1. With this arrangement, a height position (absolute value) from the optical axis of a principal ray of off axial rays within the fourth optical system L1M2 becomes relatively smaller than a height position from the optical axis of a principal ray of off axial rays on the most enlargement conjugate side of the third optical system L1M1, and becomes closer to the optical axis. Accordingly, a change in interval between the fourth optical system L1M2 and an optical system positioned further on the reduction conjugate side (lens G105 of FIG. 1) has a relatively lower sensitivity to the curvature of field as compared to a change in interval between the third optical system L1M1 and the fourth optical system L1M2. Further, the fourth optical system L1M2 is close to the substantial stop as a whole, and hence the sensitivity with respect to the back focus is still in a high state.

Through use of such a characteristic, in the projection lens L1 of Example 1, two lens groups, specifically, the third optical system L1M1 and the fourth optical system L1M2, are moved in different trajectories on the optical axis so that the measure for adjusting the curvature of field is achieved. According to Example 1, an optical system capable of satisfactorily adjusting the curvature of field with a simple configuration can be provided.

In the above-mentioned configuration, the following conditional expression is satisfied so that further satisfactory curvature adjustment can be achieved.

0.1<f12/bf<2.0 (1)

In Expression (1), f12 represents a focal length of the fourth optical system L1M2, and “bf” represents the back focus in air of the entire system. A ratio of those lengths is calculated. Expression (1) means that the fourth optical system L1M2 has a relatively strong positive power.

When the value of the ratio in Expression (1) becomes larger than the upper limit value, the power of the fourth optical system L1M2 is excessively decreased, and the correction effect at the time of adjusting the curvature of field is decreased. Thus, the movement amount at the time of the curvature adjustment is unnecessarily increased, and the optical system is increased in size. When the value of the ratio in Expression (1) becomes smaller than the lower limit value, the power of the fourth optical system L1M2 is excessively increased. Thus, the sensitivity of spherical aberration, coma, or the like at the time of adjusting the curvature of field is increased, which causes degradation of the imaging performance. In addition, the aberration of the entire optical system becomes unbalanced, which causes reduction in performance.

It is more preferred that Expression (1) further satisfy the following conditions.

0.2<f12/bf<1.5 (1a)

0.3<f12/bf<1.0 (1b)

Further, in Example 1, as a condition for forming a more preferred optical system, it is preferred that the projection lens L1 satisfy the following conditional expression.

0.1<L_ENP/L_B12<1.0 (2)

In Expression (2), L_ENP represents a distance on the optical axis from a surface of the first optical system L1E on the most enlargement conjugate side to an entrance pupil, and L_B12 represents a distance from the surface of the first optical system L1E on the most enlargement conjugate side to a surface of the fourth optical system L1M2 on the most reduction conjugate side. A ratio of those distances is calculated. Expression (2) indicates that the position of the lens group having the function of adjusting the curvature of field is relatively close to the position of the entrance pupil, and is also close to the surface of the first optical system L1E on the most enlargement conjugate side. When Expression (2) is satisfied, within the first optical system L1E, the adjusting group for adjusting the curvature of field can be set in the vicinity of a position at which the off axial rays come closer to the optical axis, and satisfactory performance can be achieved while keeping balance between the aberration of the curvature of field and the back focus correction.

When the value of the ratio in Expression (2) becomes larger than the upper limit value, the position of the entrance pupil is shifted to the reduction conjugate side. Thus, the balance in position with respect to the fourth optical system L1M2 is lost, and the back focus sensitivity is reduced. In addition, the optical system has a long focus, and thus does not satisfy the needs of the short-focus optical system. When the value of the ratio in Expression (2) becomes smaller than the lower limit value, the position of the fourth optical system L1M2 for adjusting the back focus is excessively shifted to the reduction conjugate side, and a deviation amount from the substantial pupil is increased. Thus, it becomes difficult to appropriately adjust the back focus. Further, the fourth optical system L1M2 comes close to the intermediate image, and hence the height of the off axial ray and the ray separation degree on the plane are increased, which causes an increase in astigmatism and coma.

It is more preferred that Expression (2) further satisfy the following conditions.

0.14<L_ENP/L B12<0.7 (2a)

0.18<L_ENP/L_B12<0.5 (2b)

As a more preferred condition, in the projection lens L1 of Example 1, it is preferred that the fourth optical system L1M2 be formed of a plurality of lenses and include at least two positive lenses. The fourth optical system L1M2 has a relatively strong positive power, and hence, when the fourth optical system L1M2 is intended to be formed of one positive lens, the power of the lens element becomes excessively strong. Thus, an increase in curvature may be caused to cause an abrupt increase in spherical aberration. In addition, there is a fear in terms of manufacturing. In the projection lens L1 of Example 1, in the fourth optical system L1M2, two lens elements each having a positive refractive power, specifically, the lens G103 and the lens G104, are arranged. With such a configuration, powers are appropriately distributed to a plurality of lenses so that the rays can be bent without difficulty, and satisfactory imaging performance can be achieved as the entire optical system.

As a more preferred condition, in the projection lens L1 of Example 1, it is preferred that, between a surface of the third optical system L1M1 on the most reduction conjugate side and a surface of the fourth optical system L1M2 on the most enlargement conjugate side, an intersection P at which the principal ray of the off axial rays intersects with the optical axis be present. This condition means that the position of the substantial stop in the first optical system L1E is arranged between the third optical system L1M1 and the fourth optical system L1M2 or inside of the fourth optical system L1M2. With such a configuration, the back focus correction function which is the role of the fourth optical system L1M2 can be enhanced. The projection lens L1 of Example 1 is configured so that, in the vicinity of the lens G102 arranged between the surface of the third optical system L1M1 on the most reduction conjugate side and the surface of the fourth optical system L1M2 on the most enlargement conjugate side, the intersection P at which the principal ray of the off axial rays intersects with the optical axis is present.

Further, in Example 1, as a more preferred condition, it is preferred that the projection lens L1 satisfy the following conditional expression.

0.90<|fF/fC|<1.10 (3)

In Expression (3), fF represents a focal length of the entire system at the time of projection onto the plane screen, and fC represents a focal length of the entire system after the third optical system L1M1 and the fourth optical system L1M2 which are the adjusting group for adjusting the curvature of field are driven. A ratio of those lengths is calculated. In the adjustment of the curvature of field, it is desired to suppress variations of the spherical aberration and the distortion, and to vary only the aberration of the curvature of field as satisfactorily as possible. Further, when lateral magnification variation occurs before or after the adjustment of the curvature of field, a pixel position on the screen varies, and thus a stress is felt at the time of installation. From those viewpoints, it is preferred that the variation of the focal length be small before and after the adjusting group for adjusting the curvature of field is driven.

It is more preferred that Expression (3) further satisfy the following conditions.

0.92<|fF/fC|<1.08 (3a)

0.95<|fF/fC|<1.05 (3b)

As a more preferred condition, in the projection lens L1 of Example 1, it is preferred that the fourth optical system L1M2 include a cemented lens formed of a positive lens and a negative lens. The fourth optical system L1M2 has a configuration including the substantial stop in the first optical system L1E, and hence there is a fear in that no little axial chromatic aberration occurs in the vicinity thereof. Further, the projection lens L1 of Example 1 has a re-imaging type configuration, and hence the axial chromatic aberration exhibits an addition relationship around the intermediate imaging plane IM. Thus, it is preferred that the axial chromatic aberration be appropriately corrected in each of the first optical system L1E and the second optical system L1R. When the axial chromatic aberration is increased, particularly in an optical system assuming an interchangeable lens or an optical system using a single-plate image display element, blur occurs in blue light under a state in which focus is on green light serving as a core of image light, and thus a blue fringe is caused around a pixel. This state disadvantageously causes reduction in image quality. In the projection lens L1 of Example 1, the negative lens G102 and the positive lens G103 in the fourth optical system L1M2 are cemented to each other to form the cemented lens. When the fourth optical system L1M2 includes a cemented lens formed of a positive lens and a negative lens, the fourth optical system L1M2 can serve as an achromatization configuration so as to satisfactorily correct the axial chromatic aberration. Further, projection performance suitable for the projection display apparatus can be obtained.

As a more preferred condition, it is preferred that, at the time of adjustment of the curvature of field, in the first optical system L1E, a lens most adjacent to the intermediate image do not move. The lens most adjacent to the intermediate image has a high ray separation degree, and plays an important role for aberration correction of the entire optical system, particularly in correction of distortion, chromatic aberration of magnification, and the like caused by the off axial rays. Further, the rays are separated and the off axial rays are present at high positions. Thus, the lens has a less back focus correction effect, and has a limited advantage when being movable. Further, the vicinity of the intermediate image is effective for aberration correction, and hence an aspherical lens is employed in many cases. In order to reduce a positional error of mechanical holding as well, it is preferred that the lens have a non-movable configuration. In the projection lens L1 of Example 1, in the first optical system L1E, the lens G108 adjacent to the intermediate image does not move at the time of adjustment of the curvature of field.

In the projection lens L1 of Example 1, at least a part of the third optical system L1M1 and the fourth optical system L1M2 is formed as an optical system which is movable during focusing and is also movable independently of the focusing. The focus optical system L1Foc has a configuration including the third optical system L1M1 and the fourth optical system L1M2 so as to achieve focusing. In a wide-angle optical system, the largest performance change in the variation of the projection distance is the curvature of field and the astigmatism. The third optical system L1M1 and the fourth optical system L1M2 vary the curvature of field at the same object distance while maintaining a focus state, while the focus optical system L1Foc corrects the variations of the curvature of field and the astigmatism while correcting the change in focus position caused along with the change in the projection distance. That is, it can be said that the adjustment state of the adjusting group for adjusting the curvature of field and the adjustment state of the focus optical system L1Foc both have a correction effect with respect to the curvature of field, but are states having different sensitivities with respect to the variation of the back focus. Accordingly, it is a preferred measure to divide a part of the focus group or to form the adjusting group for adjusting the curvature of field in an overlapping manner so as to achieve adjustment of the curvature of field in the third optical system L1M1 arranged on the enlargement conjugate side with respect to the intermediate image.

### EXAMPLE 2

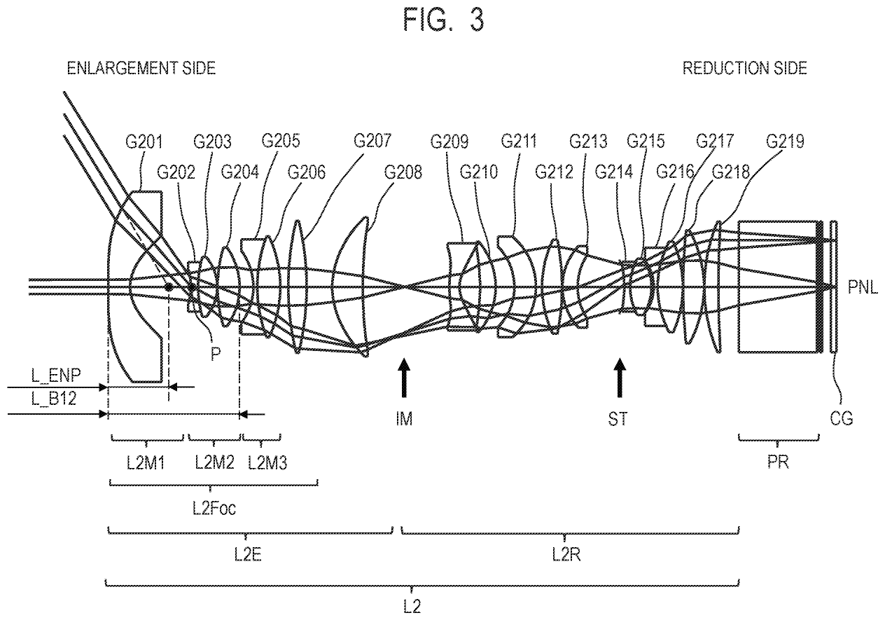

A projection lens L2 (optical system) according to Example 2 is described with reference to FIG. 3. FIG. 3 is a schematic view of the projection lens L2 of Example 2. The projection lens L2 of Example 2 is formed of nineteen lens elements of from a lens G201 to a lens G219. The projection lens L2 of Example 2 is a re-imaging type optical system having an intermediate imaging plane IM inside of the projection lens L2. The projection lens L2 of Example 2 is divided into a first optical system L2E corresponding to an enlargement conjugate side optical system and a second optical system L2R corresponding to a reduction conjugate side optical system at the intermediate imaging plane IM serving as a border. An optical configuration of each lens element and a configuration of a focus optical system L2Foc of the projection lens L2 of Example 2 are similar to the optical configurations of the projection lens L1 of Example 1, and hence description thereof is omitted.

In Example 2, at the time of adjusting the curvature of field, in the first optical system L2E, a third optical system L2M1 having a negative power, a fourth optical system L2M2 having a positive power, and a fifth optical system L2M3 having a negative power move in trajectories different from each other. The third optical system L2M1 is formed of the meniscus-shaped negative lens G201. The fourth optical system L2M2 is formed of a cemented lens of the negative lens G202 and the positive lens G203, and the positive lens G204. In addition, the fifth optical system L2M3 is formed of a cemented lens of the negative lens G205 and the positive lens G206. With this configuration, roles can be shared by the third optical system L2M1 for mainly varying the curvature of field, the fourth optical system L2M2 for correcting the back focus variation caused thereby, and the fifth optical system L2M3 for further secondarily correcting the aberration variation. The fifth optical system L2M3 plays an auxiliary role with respect to the aberration correction. When the three lens groups are movable at the time of adjustment of the curvature of field as in Example 2, more satisfactory aberration correction is allowed without difficulty.

Also in Example 2, when Conditional Expressions (1) to (3) in Example 1 are each satisfied, the projection lens L2 capable of satisfactorily adjusting the curvature of field with a simple configuration can be provided.

### EXAMPLE 3

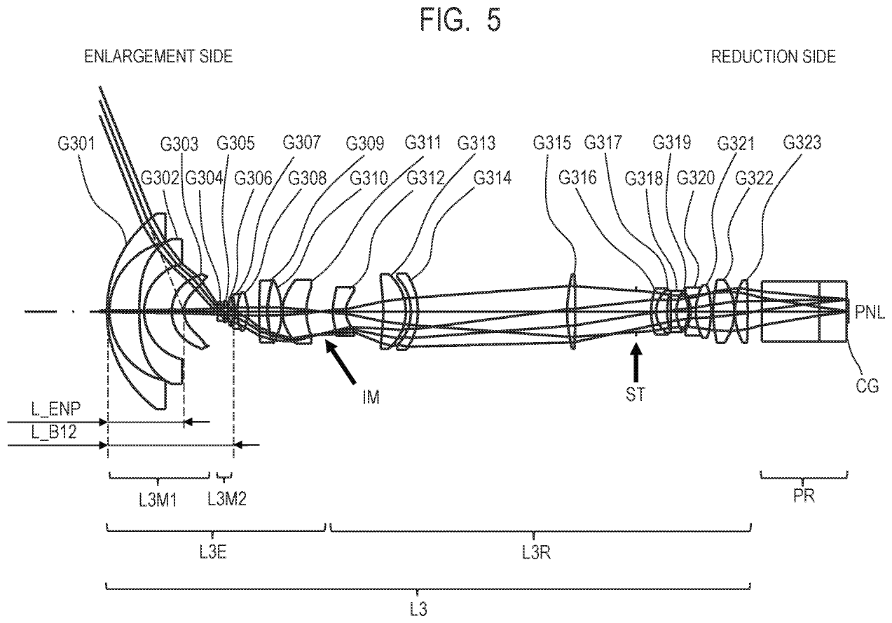

A projection lens L3 (optical system) according to Example 3 is described with reference to FIG. 5. FIG. 5 is a schematic view of the projection lens L3 of Example 3. The projection lens L3 of Example 3 is formed of twenty-three lens elements of from a lens G301 to a lens G323. The projection lens L3 of Example 3 is a re-imaging type optical system having an intermediate imaging plane IM inside of the projection lens L3. The projection lens L3 of Example 3 is divided into a first optical system L3E corresponding to an enlargement conjugate side optical system and a second optical system L3R corresponding to a reduction conjugate side optical system at the intermediate imaging plane IM serving as a border.

In Example 3, at the time of adjusting the curvature of field, in the first optical system L3E, a third optical system L3M1 being a lens group having a negative power and a fourth optical system L3M2 being a lens group having a positive power move in trajectories different from each other. The third optical system L3M1 is formed of the meniscus-shaped negative lens G301, the meniscus-shaped negative lens G302, and the meniscus-shaped negative lens G303. The fourth optical system L3M2 is formed of the negative lens G304, the positive lens G305, and the positive lens G306. In addition, the projection lens L3 of Example 3 is a very wide-angle optical system having the maximum half angle of view of 68 degrees.

Also in Example 3, when Conditional Expressions (1) to (3) in Example 1 are each satisfied, the projection lens L3 capable of satisfactorily adjusting the curvature of field with a simple configuration can be provided.

In each of Numerical Examples described below, a curvature radius of each optical surface is represented by “r”, and an axial interval (distance or line on the optical axis) between an m-th surface and an (m+1)th surface is represented by “d” (mm), where “m” is a number of a surface counted from the enlargement conjugate side. Further, a refractive index with respect to a d-line of each optical member is represented by “nd”, and an Abbe number of the optical member is represented by “vd”. The Abbe number “vd” of a certain material is expressed by the following expression:

vd=(Nd−1)/(NF−NC) (4),

where Nd, NF, and NC represent refractive indices with respect to the d-line (587.6 nm), an F-line (486.1 nm), and a C-line (656.3 nm), respectively, of the Fraunhofer lines.

In each of Numerical Examples, a focal length (mm), an F-number, and a half angle of view (degree) are all values obtained when the projection optical system of each Example is focused on an object at infinity.

Further, when the optical surface has an aspherical shape, an asterisk “*” is attached to the right side of the surface number. Regarding the aspherical shape, a displacement amount X from a surface vertex in the optical axis direction is expressed by Expression (5) below:

X=(h²/R)/[1+{1−(1+K)(h/R)²}^{1/2}+C4×h⁴+C6×h⁶+C8×h⁸C10×h¹⁰+C12×h¹²] (5)

where “h” represents a height from the optical axis in a direction perpendicular to the optical axis, R represents a paraxial curvature radius, K represents a conic constant, and C4, C6, C8, C10, and C12 represent aspherical coefficients of respective orders.

In each aspherical coefficient, “e±XX” means “×10±^{XX}.”

[Numerical Examples 1 and 2]
(Surface Data Unit: mm)
Lens Configuration

| Surface number | r | d | nd | vd |
|---|---|---|---|---|
| 1 | *−1,489.812 | 7.08 | 1.511 | 56.474 |
| 2 | *11.606 | 19.90 | | |
| 3 | −17.943 | 2.33 | 1.854 | 23.784 |
| 4 | 34.824 | 6.26 | 1.620 | 63.395 |
| 5 | −14.874 | 0.10 | | |
| 6 | 43.212 | 7.18 | 1.595 | 67.001 |
| 7 | −22.142 | 4.50 | | |
| 8 | −19.699 | 1.30 | 1.862 | 24.799 |
| 9 | 46.463 | 7.52 | 1.620 | 63.395 |
| 10 | −38.464 | 2.51 | | |
| 11 | 92.364 | 5.99 | 1.957 | 17.984 |
| 12 | −89.561 | 8.3645 | | |
| 13* | 25.399 | 10.00 | 1.768 | 49.096 |
| 14* | 175.116 | 28.22 | | |
| 15* | 27.807 | 3.30 | 1.585 | 59.385 |
| 16* | 8.767 | 6.69 | | |
| 17 | −73.980 | 5.14 | 1.888 | 40.765 |
| 18 | −22.254 | 6.09 | | |
| 19 | −18.852 | 7.06 | 1.732 | 54.679 |
| 20 | −21.311 | 2.00 | | |
| 21 | 0.000 | 0.00 | | |
| 22 | 35.176 | 6.52 | 1.595 | 68.623 |
| 23 | −75.984 | 0.10 | | |
| 24 | 19.416 | 5.00 | 1.932 | 20.880 |
| 25 | 18.894 | 13.75 | | |
| 26 | 0.000 | 1.47 | | |
| 27 | −34.818 | 1.90 | 1.862 | 24.799 |
| 28 | 19.113 | 6.98 | 1.595 | 67.001 |
| 29 | −16.851 | 0.73 | | |
| 30 | −13.972 | 1.30 | 1.862 | 24.799 |
| 31 | 31.146 | 8.19 | 1.776 | 49.598 |
| 32 | −36.466 | 0.10 | | |
| 33 | 176.364 | 6.83 | 1.767 | 48.488 |
| 34 | −37.670 | 0.10 | | |
| 35 | 54.839 | 4.59 | 1.957 | 17.984 |
| 36 | 343.760 | 10.00 | | |
| 37 | 0.000 | 28.00 | 1.519 | 64.166 |
| 38 | 0.000 | 0.26 | | |

(Aspherical Surface Data)

| Surface number | K | C4 | C6 | C8 | C10 | C12 | C14 | C16 |
|---|---|---|---|---|---|---|---|---|
| 1 | 0.00E+00 | 1.99E−05 | −2.57E−08 | −2.55E−11 | −1.44E−14 | −3.28E−18 | 0.00E+00 | 0.00E+00 |
| 2 | −9.72E−01 | −7.53E−05 | 6.16E−09 | −2.40E−09 | 3.11E−12 | −6.16E−16 | 0.00E+00 | 0.00E+00 |
| 13 | 0.00E+00 | −8.48E−06 | −4.94E−09 | −7.51E−12 | 7.37E−14 | −1.43E−16 | 0.00E+00 | 0.00E+00 |
| 14 | 0.00E+00 | 2.26E−06 | −2.40E−08 | 1.57E−10 | −3.38E−13 | 2.40E−16 | 0.00E+00 | 0.00E+00 |
| 15 | 0.00E+00 | −2.59E−04 | 1.35E−06 | −5.33E−09 | 1.26E−11 | −1.39E−14 | 0.00E+00 | 0.00E+00 |
| 16 | −1.26E+00 | −2.85E−04 | 2.05E−06 | −9.66E−09 | 2.66E−11 | −3.23E−14 | 0.00E+00 | 0.00E+00 |

(Various Data)

| | |
|---|---|
| Focal length | −9.26 |
| F-number | 1.90 |
| Half angle of view | 58.40 |
| Image height | 15.15 |

(Focal Length of Adjusting Group for adjusting Curvature of Field)

[Numerical Example 1]

| Lens group | Focal length [mm] |
|---|---|
| L1M1 | −22.487 |
| L1M2 | 20.798 |

[Numerical Example 2]

| Lens group | Focal length [mm] |
|---|---|
| L1M1 | −22.487 |
| L1M2 | 20.798 |
| L2M3 | −34.675 |

[Numerical Example 3]
(Surface Data Unit: mm)
Lens Configuration

| Surface number | r | d | nd | vd |
|---|---|---|---|---|
| 1 | 86.403 | 1.666 | 1.651 | 53.023 |
| 2 | 50.631 | 20.580 | | |
| 3* | 235.390 | 3.500 | 1.533 | 55.753 |
| 4 | 35.000 | 20.026 | | |
| 5* | 29.536 | 8.308 | 1.585 | 59.385 |
| 6* | 14.663 | 18.641 | | |
| 7 | 0.000 | 5.871 | | |
| 8 | −25.263 | 3.452 | 1.854 | 23.784 |
| 9 | 38.272 | 3.593 | 1.595 | 68.623 |
| 10 | −20.036 | 0.500 | | |
| 11 | 70.578 | 3.459 | 1.808 | 46.527 |
| 12 | −30.774 | 0.500 | | |
| 13 | −31.914 | 1.500 | 1.854 | 23.784 |
| 14 | 31.197 | 7.700 | 1.595 | 68.623 |
| 15 | −37.017 | 8.402 | | |
| 16 | 286.816 | 6.214 | 1.625 | 57.052 |
| 17 | 66.478 | 0.500 | | |
| 18 | 74.751 | 9.770 | 1.816 | 22.760 |
| 19 | −45.458 | 0.500 | | |
| 20* | 26.670 | 17.063 | 1.866 | 37.097 |
| 21* | 40.012 | 18.996 | | |
| 22* | 44.263 | 9.326 | 1.813 | 40.548 |
| 23* | 13.609 | 26.889 | | |
| 24 | −125.567 | 16.014 | 1.754 | 35.332 |
| 25 | −35.017 | 2.993 | | |
| 26 | −34.740 | 5.104 | 1.498 | 81.545 |
| 27 | −47.785 | 106.366 | | |
| 28 | 101.951 | 5.720 | 1.754 | 35.332 |
| 29 | −954.336 | 45.196 | | |
| 30 | 0.000 | 9.529 | | |
| 31 | 45.589 | 3.489 | 1.725 | 34.707 |
| 32 | 19.367 | 7.947 | 1.816 | 22.760 |
| 33 | 44.063 | 2.139 | | |
| 34 | 0.000 | 0.500 | | |
| 35 | −635.043 | 4.082 | 1.854 | 23.784 |
| 36 | 26.414 | 8.285 | 1.518 | 64.141 |
| 37 | −28.469 | 1.728 | | |
| 38 | −26.048 | 3.835 | 1.923 | 31.604 |
| 39 | 40.365 | 10.773 | 1.705 | 41.239 |
| 40 | −63.569 | 1.616 | | |
| 41 | 95.254 | 14.989 | 1.440 | 94.660 |
| 42 | −39.530 | 0.500 | | |
| 43 | 47.252 | 9.138 | 1.498 | 81.545 |
| 44 | −596.156 | 10.000 | | |
| 45 | 0.000 | 41.100 | 1.518 | 64.141 |
| 46 | 0.000 | 19.500 | 1.849 | 24.559 |
| 47 | 0.000 | 1.280 | | |

(Aspherical Surface Data)

| Surface number | K | C4 | C6 | C8 | C10 | C12 | C14 | C16 |
|---|---|---|---|---|---|---|---|---|
| 3 | 0.00E+00 | 3.51E−06 | −1.63E−09 | 4.49E−13 | 1.49E−16 | −1.07E−19 | 2.05E−23 | 0.00E+00 |
| 5 | 0.00E+00 | 6.52E−06 | 3.22E−09 | 2.08E−11 | −4.30E−14 | 2.20E−17 | 0.00E+00 | 0.00E+00 |
| 6 | −6.51E-01 | −1.92E−05 | 8.08E−08 | −1.57E−10 | −1.13E−12 | 3.21E−15 | −2.52E−18 | 0.00E+00 |
| 20 | 0.00E+00 | −6.35E−06 | −8.36E−09 | 7.07E−12 | −2.89E−14 | −2.76E−18 | 0.00E+00 | 0.00E+00 |
| 21 | 0.00E+00 | −7.80E−06 | 1.02E−08 | 1.26E−11 | −2.00E−13 | 2.88E−16 | 0.00E+00 | 0.00E+00 |
| 22 | 0.00E+00 | 8.13E−06 | −1.40E−07 | 2.67E−10 | 1.84E−14 | −3.23E−16 | 0.00E+00 | 0.00E+00 |
| 23 | −5.72E−01 | −6.57E−05 | −8.48E−08 | 4.88E−10 | −1.06E−12 | 4.01E−16 | 0.00E+00 | 0.00E+00 |

(Various Data)

| | |
|---|---|
| Focal length | −3.35 |
| F-number | 2.0 |
| Half angle of view | 68.3 |
| Image height | 8.61 |

(Focal Length of Adjusting Group for adjusting Curvature of Field)

| | |
|---|---|
| Lens group | Focal length [mm] |
| L3M1 | −21.014 |
| L3M2 | 27.309 |

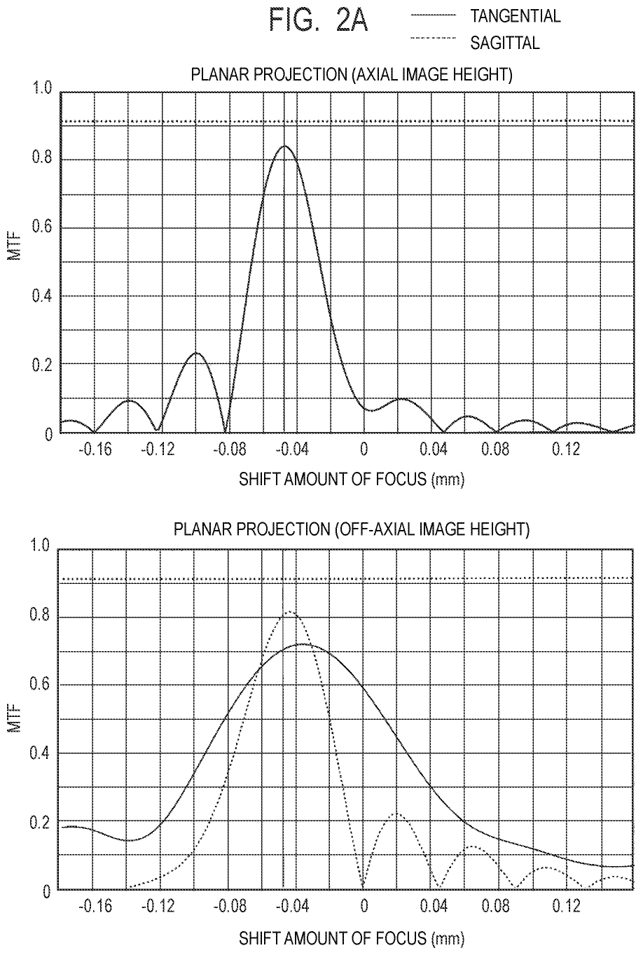

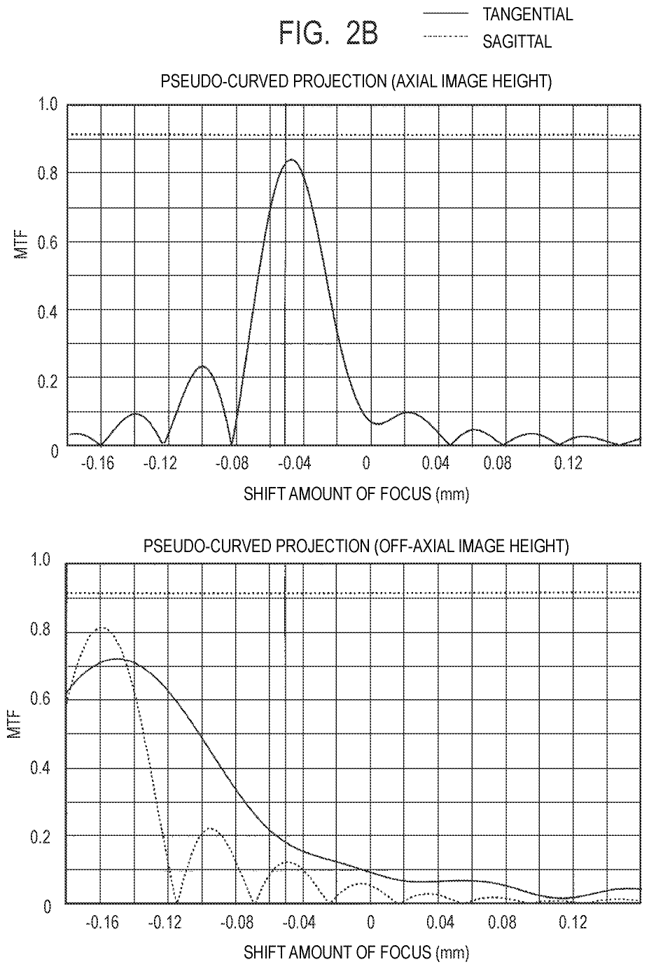

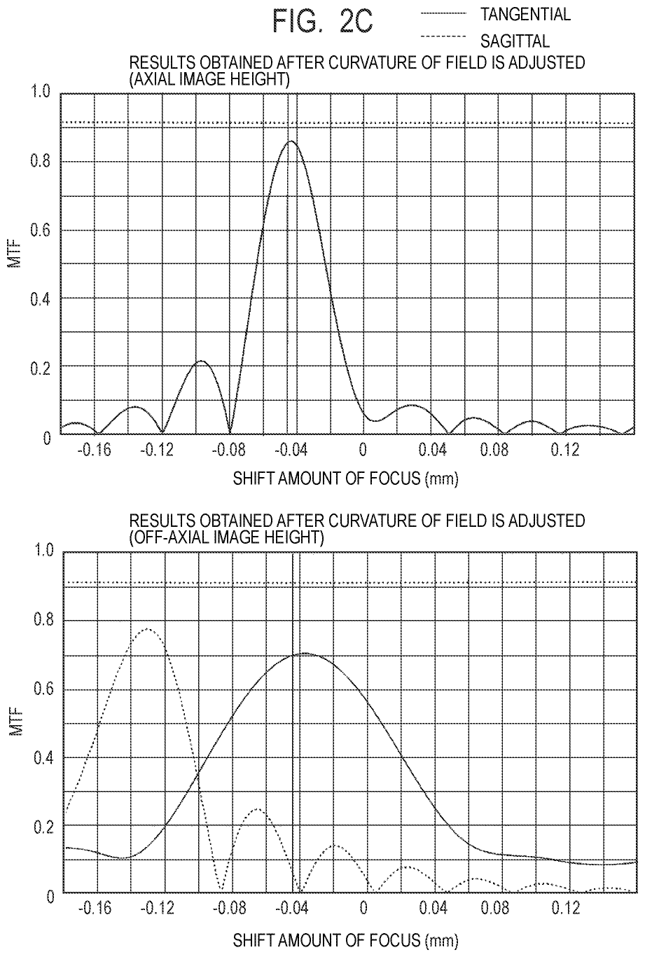

FIG. 2A to FIG. 2C show, through use of defocus MTF charts, characteristics and results obtained after the curvature of field is adjusted, when the projection lens L1 of Example 1 is used. In order to ignore differences caused by the projection distance, a defocus MTF on the reduction conjugate side is used. The upper graph of each figure shows plots of the defocus MTF of the axial image height, and the lower graph of each figure shows the defocus MTF of the off-axial image height of the image height of 15.15 mm. The solid line indicates a tangential MTF, and the broken line indicates a sagittal MTF. In the planar projection of FIG. 2A, it is shown that satisfactory focus is obtained at a defocus position of −0.05 mm (perpendicular line of FIG. 2A) at both of the axial image height and the off-axial image height.

FIG. 2B shows defocus MTF charts of a state in which a curvature of R=1,000 mm is given to the image plane on the reduction conjugate side in order to reproduce pseudo-curved projection. This state corresponds to a screen surface of R=−1,700 mm at the projection distance of 954 mm. At this time, the aberration state of the projection lens L1 maintains a flat state with respect to the curved surrounding imaging plane. Thus, it is understood that the focus of the optical axis center (axial image height) and the focus of the surrounding ray (off-axial image height) are shifted.

In FIG. 2B, the third optical system L1M1 and the fourth optical system L1M2 which are the adjusting group for adjusting the curvature of field are used to change the interval therebetween. The results obtained after the curvature of field is adjusted are shown in FIG. 2C. The peak of the tangential MTF of the surrounding ray (off-axial image height) is near the perpendicular line of FIG. 2C, and hence the tangential MTF of the off-axial image height and the tangential MTF of the axial image height match each other. Thus, it is shown that the curvature correction has been performed.

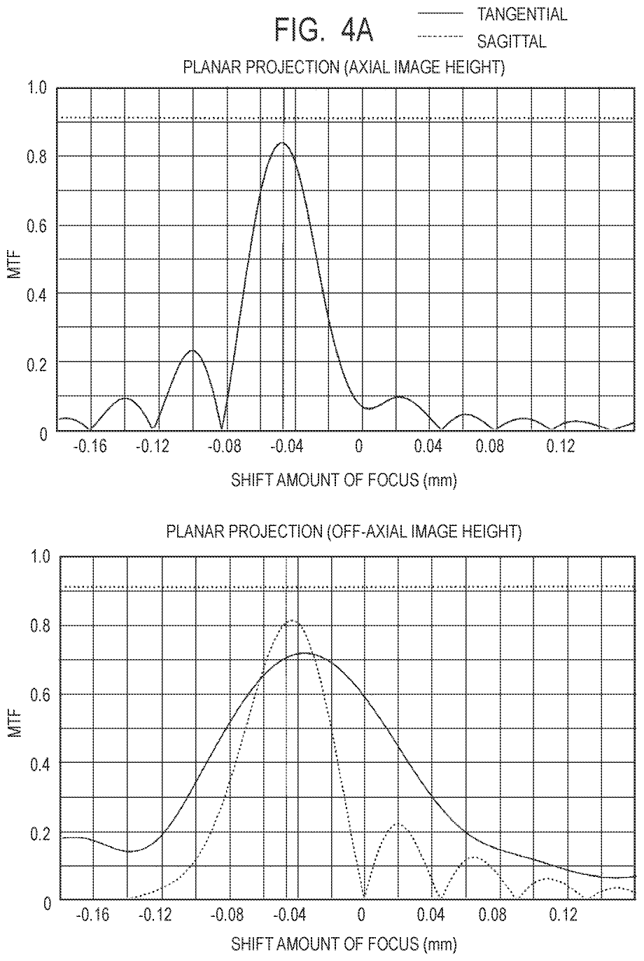

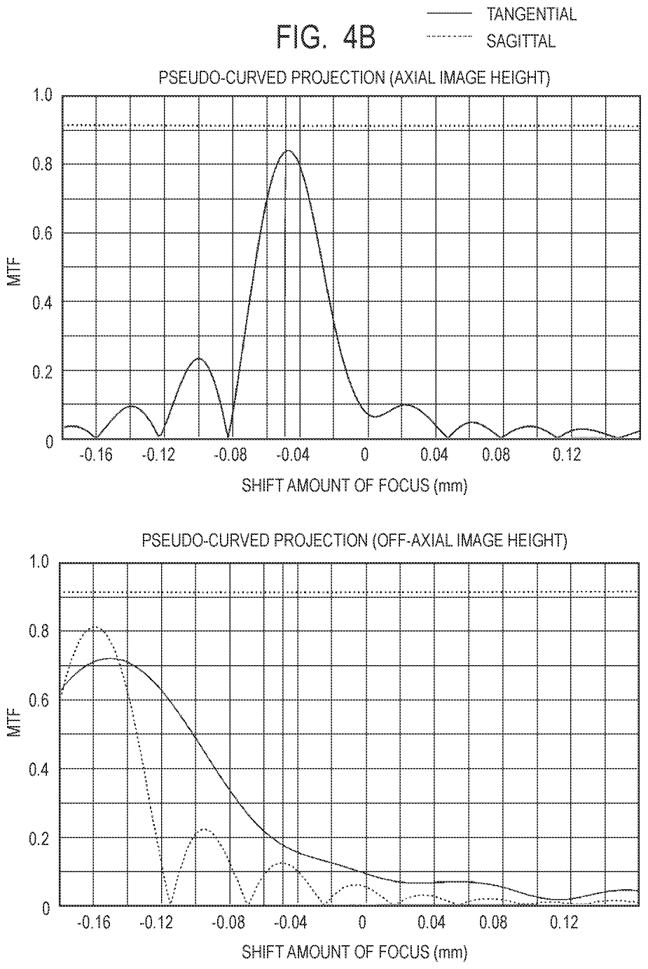

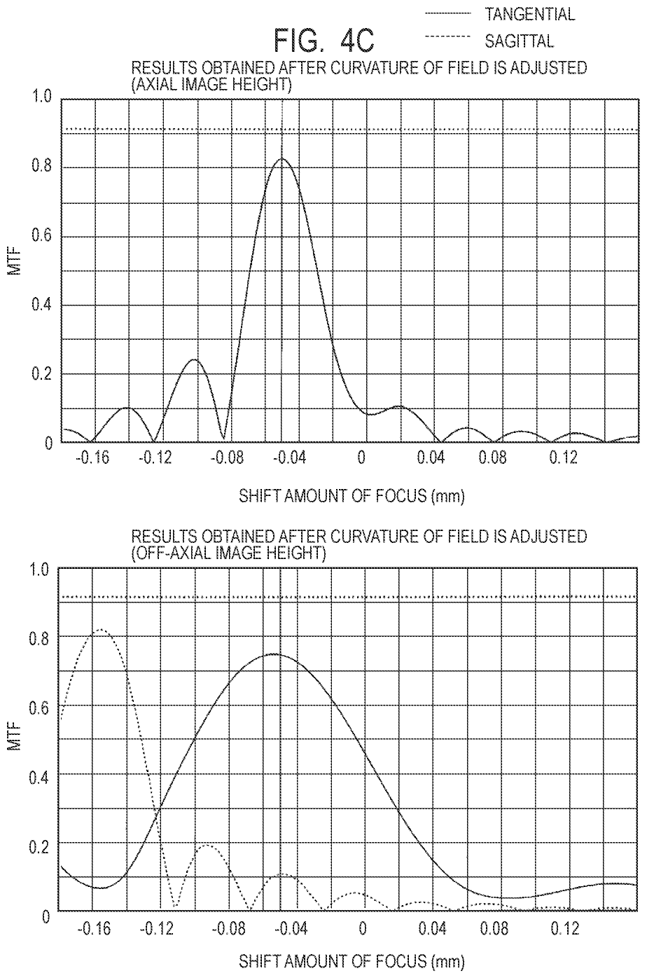

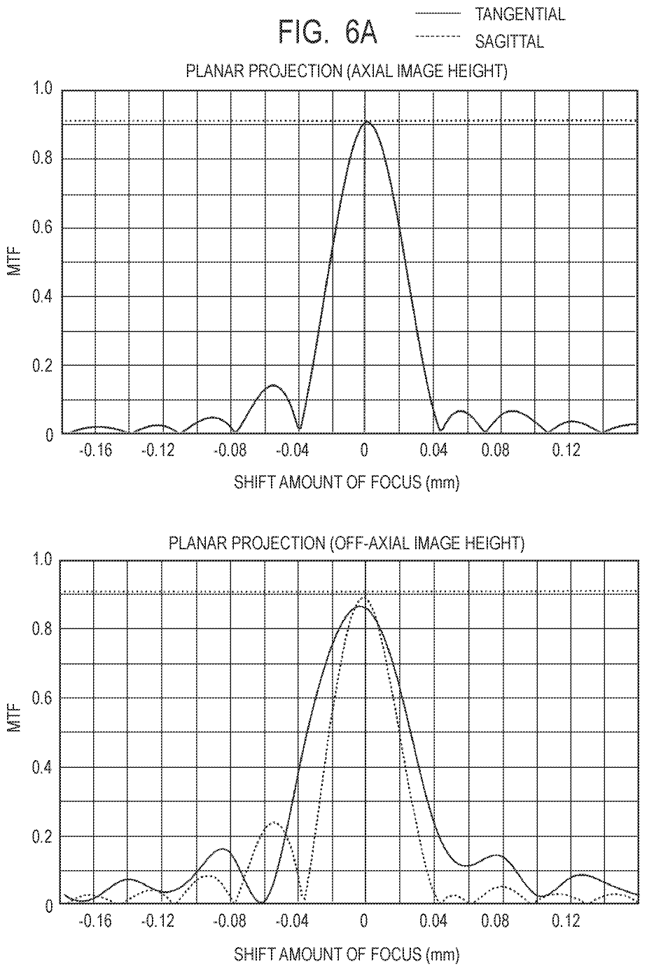

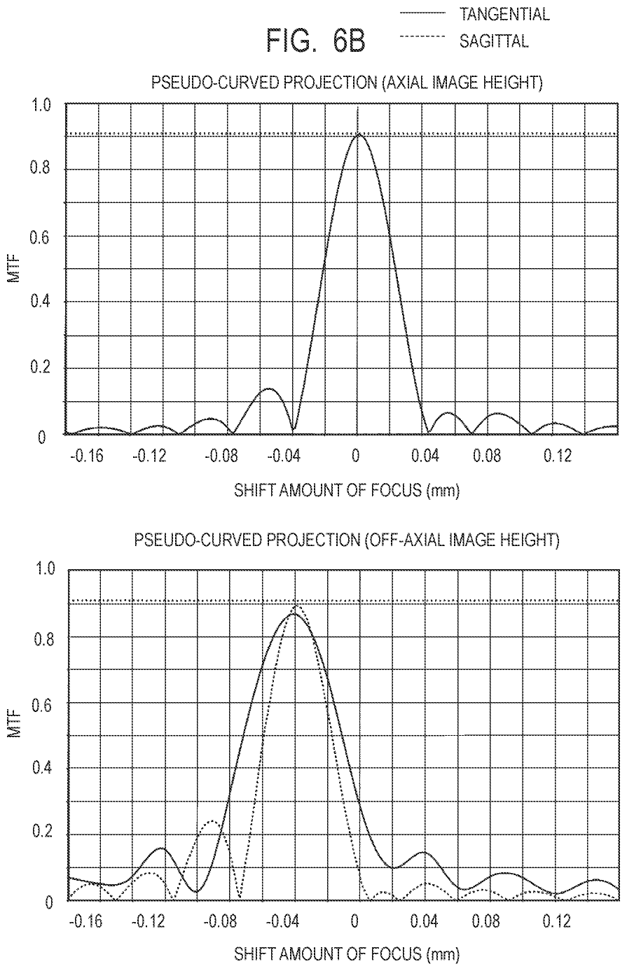

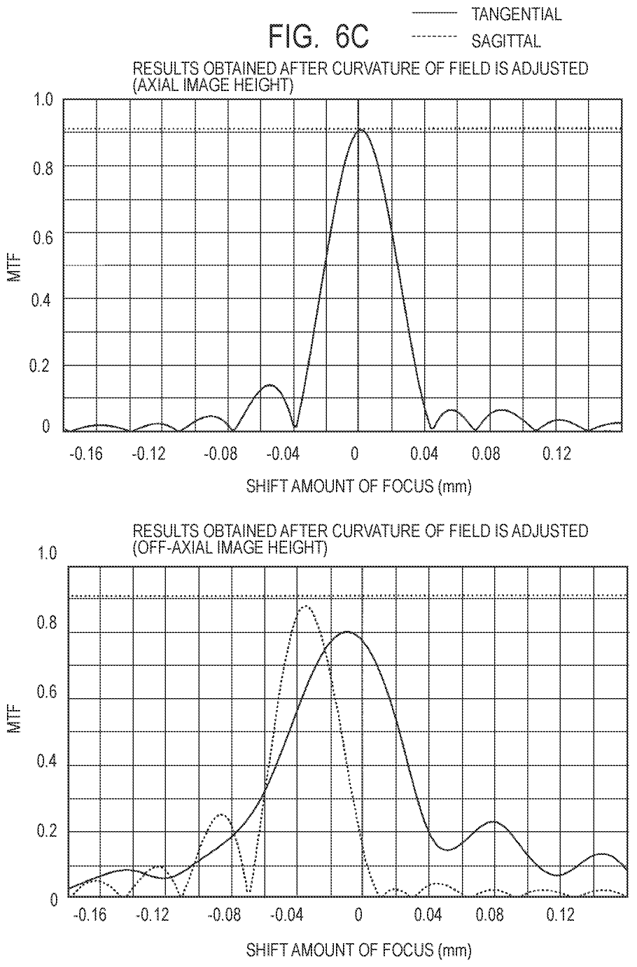

Next, FIG. 4A to FIG. 4C similarly show characteristics and results obtained after the curvature of field is adjusted, when the projection lens L2 of Example 2 is used. FIG. 6A to FIG. 6C similarly show characteristics and results obtained after the curvature of field is adjusted, when the projection lens L3 of Example 3 is used. In Example 3, a defocus position of 0 mm (perpendicular lines of FIG. 6A to FIG. 6C) is shown for both of the axial image height and the off-axial image height. FIG. 4A to FIG. 4C and FIG. 6A to FIG. 6C all show that the curvature correction has been performed.

Now, examples of a surface interval change at the time of curve adjustment in Examples 1, 2, and 3 are shown.

### Example 1

Image plane R = 1,000 mm (corresponding to screen surface
R = −1,700 mm: projection distance 954 mm)

| Surface | At time of | At time of image |
|---|---|---|
| interval “d” | non-adjustment | plane adjustment |
| Second surface | 19.90 | 19.93 |
| Seventh surface | 4.50 | 4.41 |

### Example 2

Image plane R = 1,000 mm (corresponding to screen surface
R = −1,700 mm: projection distance 954 mm)

| Surface | At time of | At time of image |
|---|---|---|
| interval “d” | non-adjustment | plane adjustment |
| Second surface | 19.90 | 19.85 |
| Seventh surface | 4.50 | 4.56 |
| Tenth surface | 2.51 | 2.54 |

### Example 3

Image plane R = 1,000 mm (corresponding to screen surface
R = −1,700 mm: projection distance 459 mm)

| Surface | At time of | At time of image |
|---|---|---|
| interval “d” | non-adjustment | plane adjustment |
| Seventh surface | 5.87 | 6.00 |
| Twelfth surface | 0.50 | 0.40 |

Table 1 below shows values of parameters and calculation results of Conditional Expressions (1) to (3) in Examples 1 to 3.

TABLE 1

| | Example 1 | Example 2 | Example 3 |
|---|---|---|---|
| f12 | 20.80 | 20.80 | 27.31 |
| BF | 28.72 | 28.72 | 48.9 |
| L_ENP | 16.72 | 16.72 | 42.37 |
| L_B12 | 42.88 | 42.88 | 89.60 |
| fF | −9.26 | −9.26 | −3.35 |
| fC | −9.25 | −9.28 | −3.33 |
| (1) | 0.72 | 0.72 | 0.56 |
| (2) | 0.39 | 0.39 | 0.47 |
| (3) | 1.00 | 1.00 | 1.01 |

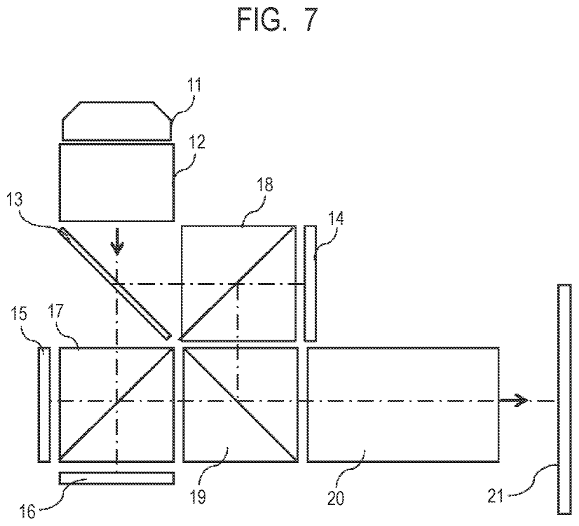

FIG. 7 is a schematic view of a projection display apparatus which has mounted thereon a projection optical system (projection lens unit 20) of any of Examples of the present disclosure, and includes an image display element for modulating light of each of a plurality of color components. The alternate long and short dash line of FIG. 7 indicates the optical axis.

With reference to FIG. 7, the projection display apparatus according to one mode of an embodiment of the present disclosure is described. Light emitted from a light source 11 enters an illumination optical system 12 so as to be converted into polarized light having a polarization direction in a predetermined direction. Light (white light) from the illumination optical system 12 is separated into three color light beams of R, G, and B by a color separation optical system formed of a color separation mirror 13 and a polarization beam splitter 17. One color beam of the three color beams is guided to a reflective light crystal panel 14 via a polarization beam splitter 18 so as to be modulated and reflected. The other two light beams separated by the polarization beam splitter 17 are guided to reflective light crystal panels 15 and 16, respectively, so as to be modulated and reflected. The three color light beams exiting from the reflective light crystal panels 14 to 16 are combined by a color combination optical system formed of the polarization beam splitters 17 and 18 and a color combination prism 19 so as to be projected onto a projection surface 21 by the projection lens unit 20.

In this embodiment, the reflective light crystal panels 14, 15, and 16 are used as the image modulation element, but the present disclosure is not limited thereto. For example, a DMD may be used, or transmissive liquid crystal display elements may be used. In those cases, it is desired to select the illumination optical system 12 as appropriate for each case.

Each of the projection lenses L1 to L3 of Examples of the present disclosure is a re-imaging type optical system having the intermediate imaging plane IM inside of each of the projection lenses L1 to L3. More specifically, each of the projection lenses L1 to L3 has a lens configuration in which a screen corresponding to an enlargement conjugate side imaging plane and the intermediate imaging plane IM inside of each of the projection lenses L1 to L3 are conjugate with each other, and further the intermediate imaging plane IM inside of each of the projection lenses L1 to L3 and the imaging plane PNL on the reduction conjugate side are conjugate with each other. Further, the description is given above about an optical system for projecting an image displayed on an image display apparatus corresponding to the reduction conjugate side imaging plane onto the screen corresponding to the enlargement conjugate side imaging plane, but the present disclosure is not limited to the above-mentioned optical system. The present disclosure may be used as an image pickup optical system to be used in a camera or the like. Further, the adjustment of the curvature of field in the present disclosure is performed at the time of projection onto the curved screen by the optical system of the present disclosure, but the present disclosure is not limited to the projection onto the curved screen. The curvature of field may be adjusted at the time of projection onto a plane screen.

The exemplary embodiments and Examples of the present disclosure are described above, but the present disclosure is not limited to those embodiments and Examples and can be modified and changed variously within the scope of the gist thereof.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-145151, filed Sep. 7, 2021, which is hereby incorporated by reference herein in its entirety.

What is claimed is:

1. An optical system comprising:
a first optical system configured to form an intermediate image from an enlargement conjugate side toward a reduction conjugate side; and
a second optical system configured to image the intermediate image onto an imaging plane on the reduction conjugate side,
wherein the first optical system at least includes a first lens unit having a negative refractive power and a second lens unit having a positive refractive power,
wherein the second lens unit is arranged on the reduction conjugate side with respect to the first lens unit, and
wherein the first lens unit and the second lens unit are configured to move in different trajectories on an optical axis so that curvature of field is adjusted.

2. The optical system according to claim 1, wherein the following expression is satisfied:
0.2<f12/bf<2.0,
where f12 represents a combined focal length of the second lens unit, and “bf” represents a back focus in air of an entire system.

3. The optical system according to claim 1, wherein the following expression is satisfied:
0.1<L_ENP/L_B12<0.6,
where L_ENP represents a distance on the optical axis from a surface of the first optical system on the most enlargement conjugate side to an entrance pupil, and L_B12 represents a distance on the optical axis from the surface of the first optical system on the most enlargement conjugate side to a surface of the second lens unit on the most reduction conjugate side.

4. The optical system according to claim 1, wherein the second lens unit is formed of a plurality of lenses, and includes at least two positive lenses.

5. The optical system according to claim 1, wherein, between a surface of the first lens unit on the most reduction conjugate side and a surface of the second lens unit on the most reduction conjugate side, a point at which a principal ray of off axial rays intersects with the optical axis is present.

6. The optical system according to claim 1, wherein the following expression is satisfied:
0.90<|fF/fC|<1.10,
where fF represents a focal length of an entire system at time of projection onto a plane screen, and fC represents a focal length of the entire system after the first lens unit and the second lens unit which are an adjusting group for adjusting the curvature of field are driven.

7. The optical system according to claim 1, wherein the second lens unit includes a cemented lens formed of a positive lens and a negative lens.

8. The optical system according to claim 1, wherein, at time of adjusting the curvature of field, in the first optical system, a lens adjacent to the intermediate image is configured not to move.

9. The optical system according to claim 1, wherein at least a part of the first lens unit and the second lens unit is movable during focusing, and is also movable independently of the focusing.

10. The optical system according to claim 1, wherein the curvature of field is adjusted at time of projection onto a curved screen.

11. A projection display apparatus comprising an optical system mounted thereon, the optical system including:
a first optical system configured to form an intermediate image from an enlargement conjugate side toward a reduction conjugate side; and
a second optical system configured to image the intermediate image onto an imaging plane on the reduction conjugate side,
wherein the first optical system at least includes a first lens unit having a negative refractive power and a second lens unit having a positive refractive power,
wherein the second lens unit is arranged on the reduction conjugate side with respect to the first lens unit, and
wherein the first lens unit and the second lens unit are configured to move in different trajectories on an optical axis so that curvature of field is adjusted.
